(19) United States
(12) Patent Application Publication
(10) Pub. No.: US 2026/0271842 A1
(43) Pub. Date: Sep. 17, 2026

(54) REMOTE CONTROL BOX INTEGRATED WITH DISTRIBUTION BOARD FOR SMART FARM IRRIGATION

(71) Applicant: KOREA AGRICULTURE INSTITUTE CORPORATION, Sejong (KR)

(72) Inventors: Hyo-Hoon PARK, Sejong (KR); Hyeonho YOON, Sejong (KR); Hyo Jong KIM, Sejong (KR); Min-hyuk LEE, Sejong (KR)

(21) Appl. No.: 19/164,012

(22) PCT Filed: Mar. 8, 2024
(86) PCT No.: PCT/KR2024/003015

§ 371 Date: Sep. 10, 2025

(30) Foreign Application Priority Data
Mar. 10, 2023 (KR) 20-2023-0000473
May 8, 2023 (KR) 20-2023-0000905

(51) Int. Cl. A01G 25/16; G01F 23/70; H02G 3/08; H02G 3/18

(52) U.S. Cl. CPC A01G 25/16; G01F 23/703; H02G 3/081; H02G 3/18

(57) ABSTRACT

The present utility model relates to a remote control systems in which electronic components required for wireless communication remote control of an irrigation system of a smart farm are compactly installed together with a power supply distribution board, wherein the distribution board includes a molded case circuit breaker and an earth leakage breaker, and remote control components include a wireless remote relay for controlling an electronic valve, a wireless remote relay for a pump, a transformer for power supply of the electronic valve, and a water level sensing controller for a water tank. By installing the above components in a transparent waterproof box that allows electromagnetic waves to pass through for wireless communication and is waterproof from rain and wind for outdoor installation, reliability and safety are provided. In addition, the remote control systems provides installation convenience by installing a power input plug, a pump power socket, a connector terminal for a water level sensing sensor line, and a connector terminal for an electronic valve power line, thereby easily connecting with external power, pumps, sensors, and electronic valves.

### TECHNICAL FIELD

The present disclosure relates to a remote control systems in which electronic components required for wireless communication remote control of an irrigation system of a smart farm are compactly installed together with a power supply distribution unit, wherein the distribution unit includes a molded case circuit breaker and an earth leakage breaker, an electronic valve control unit includes a wireless remote relay for an electronic valve, a transformer, and a connector terminal for an electronic valve power line, and a pump control unit includes a wireless remote relay for a pump, a water level sensing controller for a water tank, and a connector terminal for a power line of a water level sensing ball sensor.

More specifically, by compactly providing, within a single control systems, relays capable of remotely controlling, via wireless communication, a drain pump and an electronic valve used in an irrigation system for supplying water to a crop cultivation farm, together with a water level sensing ball sensor controller, convenience of multifunctional integrated management is provided. The above components are installed in a transparent waterproof box that allows electromagnetic waves to pass through for wireless communication and is waterproof from rain and wind for outdoor installation, thereby providing reliability and safety. In addition, the remote control systems provides installation convenience by including a power input plug, a pump power socket, a connector terminal for an electronic valve power line, and a connector terminal for a water level sensing ball sensor power line, thereby easily connecting with external power/drain pumps/electronic valves/sensors.

### BACKGROUND

Irrigation systems for supplying water to crop cultivation farms are widely distributed. In order to remotely control a crop cultivation irrigation system, a system capable of remotely controlling a drain pump and an electronic valve is essentially required. Existing remote control systems for smart farms are mostly integrated systems in which sensors for humidity and temperature and irrigation control components are combined, which leads to a high cost burden and includes many unnecessary functions for small-scale farms, thereby reducing efficiency. In small-scale farms, there is an urgent need for a system capable of effectively remotely controlling core functions of irrigation; however, no practical system has been available that may guarantee installation convenience and stability. Since only individual components such as electronic valves and remote relays are sold, if a general farm attempts to individually install these electrical and communication components, the work becomes cumbersome and there arises a problem of safety concerns.

### DETAILED DESCRIPTION OF THE INVENTION

### Technical Problem

Accordingly, the present disclosure provides a remote control systems dedicated for irrigation, which may be easily installed and safely used in small-scale farms without requiring much expertise in communication and electronic products.

### Technical Solution

The present disclosure provides a remote control systems for smart farm irrigation combined with a distribution board.

The remote control systems, implemented to block rain and wind while allowing electromagnetic waves to pass through, comprises: a power input plug supplied with power; at least one molded case circuit breaker or at least one earth leakage breaker connected to the power input plug for electrical safety; at least one wireless remote relay for an electronic valve, connected to at least one of the molded case circuit breaker or the earth leakage breaker, to remotely control at least one irrigation electronic valve; at least one connector terminal, connected to the wireless remote relay for the electronic valve, to mount a power line of the electronic valve; at least one wireless remote relay for a pump, connected to at least one of the molded case circuit breaker or the earth leakage breaker, to remotely control a drain pump for irrigation; and at least one pump power socket, connected to the wireless remote relay for the pump, to mount a power line of the drain pump.

### Effects of the Invention

By connecting multiple electronic valves and drain pumps to a wireless communication network via WiFi through wireless remote relays using the remote control systems of the present disclosure, remote control may be performed from any region where wireless communication is available beyond the installation site of the remote control systems.

By installing a water level sensing controller inside the remote control systems and interlocking the water tank water level sensing sensor with pump power control, idle running of the drain pump may be avoided, thereby enabling safe remote control of the drain pump.

By installing a molded case circuit breaker and an earth leakage breaker inside the remote control systems to supply power to each component, electrical safety may be secured.

By appropriately arranging connector terminals inside the remote control systems to be connectable to power lines of external equipment, external electronic valve power lines, pump power lines, and water level sensing ball sensor power lines may be easily connected and managed in an organized manner.

By installing an application provided by the wireless remote relay product mounted in the remote control systems on a smartphone, tablet, or PC, an entire irrigation system of a farm may be easily remotely controlled.

By appropriately connecting an led indicator to the connector terminal, an on-off state of each electronic valve power and pump power may be visually or camera-observably monitored, thereby easily determining an operating state of the remote control systems. When a user installs a WiFi remote control camera to observe the remote control systems and surrounding irrigation systems, anxiety caused by being away from the site may be relieved, and an opportunity to take measures upon problem detection may be provided. In addition, when a user installs a soil hygrometer and a remote control camera capable of observing the soil hygrometer, or installs a hygrometer sensor capable of wireless communication, the irrigation systems may be remotely controlled based on remote observation of soil moisture of the farm.

The remote control systems of the present disclosure, as described above, may add remote sensing and remote observation functions, and thus may serve as a central platform for constructing smart farms in small-scale farms and gardens.

### BRIEF DESCRIPTION OF THE DRAWINGS

FIG. 1 is a schematic diagram of an external irrigation systems controlled by a remote control systems of the present disclosure.

FIG. 2 is a block diagram schematically illustrating remote control systems, in which a plurality of electronic valves are remotely controlled and one drain pump is remotely controlled, according to one embodiment.

FIG. 3 is a block diagram schematically illustrating remote control systems, in which a plurality of electronic valves are remotely controlled and one drain pump interlocked with a water level sensing sensor is remotely controlled, according to another embodiment.

FIG. 4 is a plan layout view specifically illustrating components constituting the remote control systems of FIG. 2.

FIG. 5 is a plan layout view specifically illustrating components constituting the remote control systems of FIG. 3.

FIG. 6 is a circuit diagram of the remote control systems of FIG. 4.

FIG. 7 is a circuit diagram of the remote control systems of FIG. 5.

### EMBODIMENTS OF THE INVENTION

Hereinafter, various embodiments of the present disclosure will be described with reference to the accompanying drawings.

In the following, the present disclosure provides remote control systems for smart farm irrigation combined with a distribution board.

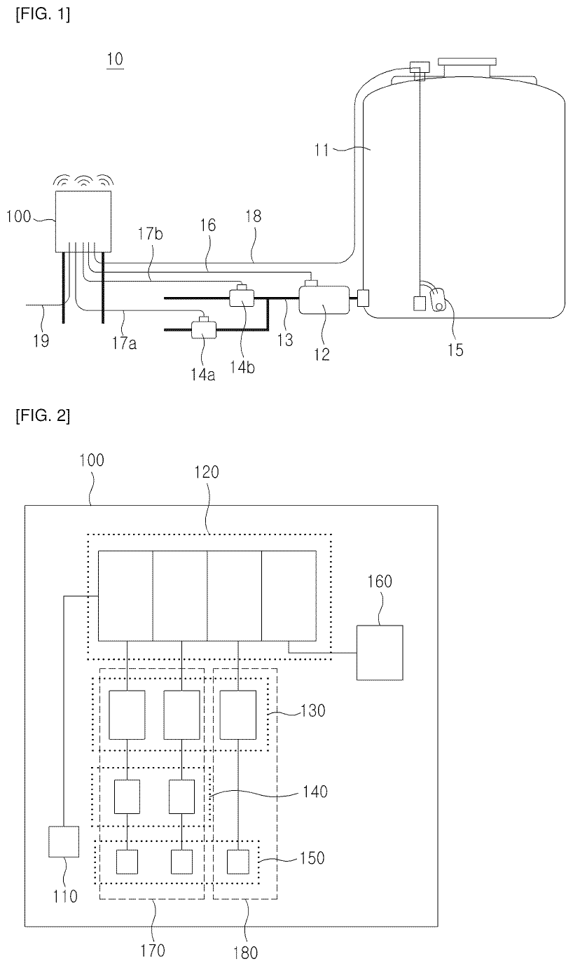

FIG. 1 is a schematic diagram of an external irrigation system 10 controlled by the remote control systems 100 of the present disclosure.

Referring to FIG. 1, the irrigation system 10 to be controlled by the remote control systems 100 of the present disclosure is a typical farm irrigation system provided with a water tank 11, a drain pump 12, and an irrigation pipe 13.

The drain pump 12 functions to pump water from the water tank 11. The drain pump 12 is connected to the irrigation pipe 13 that supplies water to the farm, and an irrigation pipe 13 at the rear end of the drain pump 12 is generally equipped with a manual valve, but for remote control, electronic valves 14a and 14b for electronically switching on and off are installed as illustrated. The electronic valves 14a and 14b function to selectively open and close the irrigation pipe 13 when the irrigation pipe 13 is branched into a plurality of directions. Even when there is only one irrigation pipe 13, installation of the electronic valves 14a and 14b is necessary to prevent unintended outflow of water through the irrigation pipe 13, since many models of the drain pump 12 used in farms remain in a state in which the pipe inside the drain pump 12 is open while the power is off, resulting in a problem that water filled in the water tank 11 flows out through the drain pump 12 by gravity. Accordingly, in order to remotely control the irrigation system 10, remote control of the drain pump 12 and the electronic valves 14a, 14b is an essential task to be solved.

In addition, since many models of the drain pump 12 generally do not have a function of sensing water pressure, the motor may continue to operate even when water has run out, which may cause the drain pump 12 to fail due to overheating. To prevent such a problem, in a general irrigation system 10, as illustrated, a water level sensing ball sensor 15 is installed inside the water tank 11 and interlocked with power supply of the drain pump 12. When water runs out in the water tank 11, a ball of the water level sensing ball sensor 15 falls downward and functions to turn off power of the drain pump 12. When water is filled again in the water tank 11 and the water level sensing ball sensor 15 floats upward, the water level sensing ball sensor 15 functions to turn on power of the drain pump 12 again. A function of turning on and off power of the drain pump 12 according to a water level sensed by the water level sensing ball sensor 15 is performed by a water level sensing controller, and installing the water level sensing controller inside the remote control systems 100 and interlocking the water level sensing controller with the remotely controlled drain pump 12 is also a major task to be solved in the present disclosure.

For reference, water supply into the water tank 11 is generally provided by using groundwater or tap water, and most supply pumps for pumping groundwater are equipped with a pressure sensing function such that when a valve of a supply pipe is closed, the supply pump is automatically turned off. Tap water supply is also automatically stopped when a valve of the supply pipe is closed. Accordingly, in the supply pipe for supplying water to the water tank 11, the problem may be solved by installing a mechanical ball, commonly referred to as a “ball tap,” which functions in the same manner as a ball installed in a flush toilet tank, in which the ball floats upward when water is filled and mechanically closes the valve of the supply pipe. Therefore, a remote control function for the supply pump is not considered in the present disclosure.

As described above, since most drain pumps 12 used in farms are not equipped with built-in water pressure sensors, they do not have a function of automatically turning off during idle running, and they also do not have a function of blocking water flow inside the drain pump 12 when the drain pump 12 is turned off. Therefore, many farmers suffer inconvenience in that they must connect a separate valve to the drain pump 12 and manually operate it. In addition, even when using the ball sensor 15 and the electronic valve 14, only installation methods introduced in individual products are provided, and thus it is difficult to configure a system capable of remotely controlling interlocked functions. Furthermore, when investigating power supply used in the above products, the drain pump 12 is often AC220V, while the electronic valve is often several tens of volts of AC or DC, thereby having different voltages. Moreover, the ball sensor 15 often uses wires that cannot withstand high current of AC220V, causing confusion in power connection and raising concerns about safety accidents due to incorrect connection. Accordingly, another major task to be solved in the present disclosure is to integrate functions for interlocked control into a single remote control systems 100, thereby enabling safe and convenient connection of power lines of various related devices.

The major tasks to be solved in the present disclosure may be summarized as follows:
(1) a remote control function of electronic valves 14a, 14b;
(2) a remote control function of the drain pump 12;
(3) an automatic control function of the drain pump 12 interlocked with the water level sensing ball sensor 15 in the water tank 11;
(4) a function of safely and easily electrically connecting the pump power line 16, electronic valve power lines 17 a, 17 b, and the water level sensing ball sensor power line 18; and
(5) integrated installation of the above functions in the single remote control systems 100 that allows electromagnetic waves for wireless communication to pass through and is waterproof from rain and wind.

Accordingly, in order to solve the major tasks as described above, the present disclosure is implemented as follows.

In order to safely operate a plurality of electronic valves 14a, 14b as well as the drain pump 12 requiring high power, to protect devices from rain, wind, and lightning when the remote control systems 100 is installed outdoors, and to protect users from electric leakage accidents, an appropriate number of molded case circuit breakers and earth leakage breakers are installed in the remote control systems 100 to supply power to components for remote control.

For remote control of the electronic valves 14a, 14b, a wireless remote relay controlled by wireless communication such as WiFi and a transformer for converting AC220V into a lower voltage are installed in the remote control systems 100 and are connectable to the electronic valve power lines 17a, 17b.

For remote control of the drain pump 12, another wireless remote relay controlled by wireless communication is installed after another earth leakage breaker and is connectable to the pump power line 16.

For interlocking the water level sensing ball sensor 15 of the water tank 11 with the drain pump 12, a water level sensing controller is installed in the remote control systems 100 and is appropriately connectable to the wireless remote relay and the pump power line.

In order to easily electrically connect the electronic valves 14a, 14b, the drain pump 12, and the water level sensing ball sensor 15 of the external irrigation system 10, connector terminals are appropriately installed in the remote control systems 100.

In order to visually or camera-observably monitor on-off states of power of each of the electronic valves 14a, 14b and the drain pump 12, led indicators are appropriately installed on the respective connector terminals.

Now, the remote control systems 100 of the present disclosure will be described.

FIG. 2 is a block diagram schematically illustrating a remote control systems 100, in which a plurality of (e.g., two) electronic valves 14 and one drain pump 12 are respectively remotely controlled, according to one embodiment.

Referring to FIG. 2, the remote control systems 100 is configured of a control box power input unit 110, a distribution unit 120, an electronic valve control unit 170, a pump control unit 180, and an external power output unit 160. The electronic valve control unit 170, in detail, is configured of a wireless remote relay unit 130, a transformer unit 140, and a connector terminal unit 150 for external equipment. The pump control unit 180, in detail, is configured of a wireless remote relay unit 130 and a connector terminal unit 150 for external equipment.

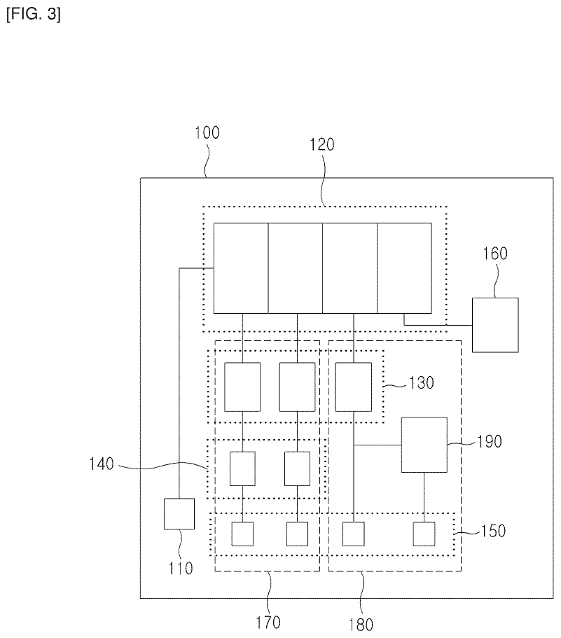

FIG. 3 is a block diagram schematically illustrating a remote control systems 100, in which a plurality of (e.g., two) electronic valves are remotely controlled, and one drain pump 12 interlocked with a water level sensing ball sensor 15 is remotely controlled, according to another embodiment.

Referring to FIG. 3, the pump control unit 180 further includes a water level sensing controller unit 190, in which the water level sensing controller unit 190 is connected between the wireless remote relay unit 130 and the connector terminal unit 150 of the pump control unit 180, and an additional connector terminal for connecting to the water level sensing ball sensor 15 is added to the connector terminal unit 150. The remaining control box power input unit 110, distribution unit 120, electronic valve control unit 170, and external power output unit 160 are the same as in the above-described embodiment with reference to FIG. 2.

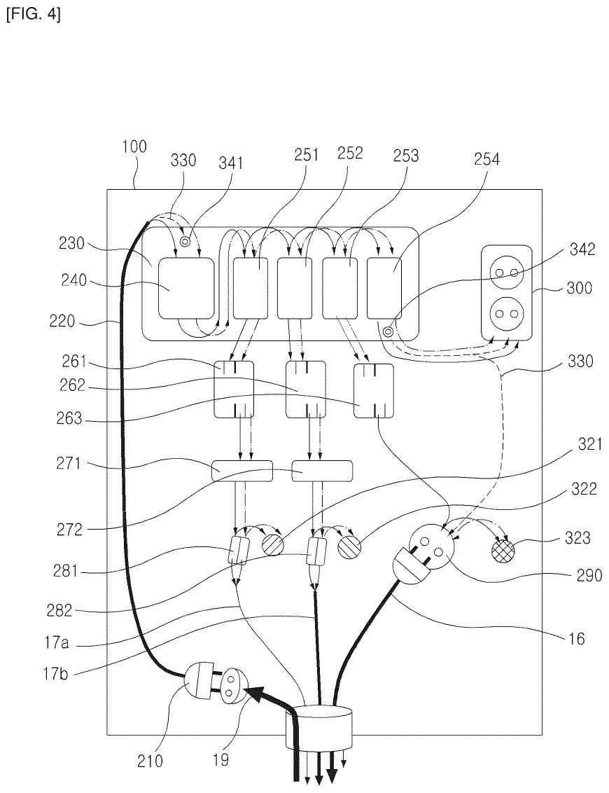

FIG. 4 is a plan layout view specifically illustrating components constituting the remote control systems 100 of FIG. 2.

Referring to FIG. 4 together with FIG. 2, functions and arrangements of components of the remote control systems 100 of FIG. 2 are illustrated.

In the control box power input unit 110, a power input plug 210 connectable to a socket of an input power line 19 outside the remote control systems 100 is installed to supply power to the remote control systems 100. The input power voltage supplies an AC voltage such as AC220V or AC110V, which is used for a general agricultural drain pump 12.

In the distribution unit 120, an internal input power line 220 connected to the power input plug 210 inside the remote control systems 100 is connected in series to a molded case circuit breaker 240 or an earth leakage breakers 251. When the internal input power line 220 is connected to the molded case circuit breaker 240, the molded case circuit breaker 240 is connected in series to a first earth leakage breakers 251. When there are two or more devices to be remotely controlled, two or more earth leakage breakers 251, 252, 253, 254 are installed, and the earth leakage breakers 251, 252, 253, 254 are connected in parallel, while devices to be supplied with power through the earth leakage breakers 251, 252, 253, 254 are connected in series to each of the earth leakage breakers 251, 252, 253, 254. The molded case circuit breaker 240 and the plurality of earth leakage breakers 251, 252, 253, 254 may also be installed in the remote control systems 100 by using a 1xN distribution board 230 in which the molded case circuit breaker 240 and the plurality of earth leakage breakers are combined.

In the wireless remote relay unit 130 of the electronic valve control unit 170, in order to remotely control specific electronic valves 14a, 14b, each wireless remote relay 261, 262 that is turned on and off through wireless communication is connected in series to specific earth leakage breakers 251, 252.

Since the electronic valves 14a, 14b generally use a low voltage such as AC24V, it is necessary to provide a transformer unit 140 for stepping down voltage to control the electronic valves 14a, 14b, and a transformer 271 of the transformer unit 140 is connected in series to the wireless remote relay 261. At an end of an output line of the transformer 271, it is necessary to provide a connector terminal unit 150 to which a power line 17a of an external electronic valve 14a may be mounted, and a connector terminal 281 capable of easily mounting two wires is installed in the connector terminal unit 150 so that the power line 17a of the external electronic valve 14a may be mounted.

Similarly, in order to remotely control another electronic valve 14b, another wireless remote relay 262, a transformer 272, and a connector terminal 282 are respectively installed on another earth leakage breaker 252 in the same connection structure as the connection of the electronic valve 14a. When an additional electronic valve is to be controlled, the above components may be connected to another earth leakage breaker 254 in the same connection structure.

When power of a specific electronic valve 14a, 14b is used at the same voltage as supply power of the remote control systems 100 (for example, AC220V), in the above connection structure, the transformers 271, 272 are omitted, and the earth leakage breakers 251, 252, the wireless remote relays 261, 262, and the connector terminals 281, 282 are sequentially connected in series.

In the pump control unit 180, another wireless remote relay 263 and a pump power socket 290 are sequentially connected in series to another earth leakage breaker 253.

The external power output unit 160 is provided for supplying power to an external device, and in the external power output unit 160, a general output power socket 300 is connected in series to a remaining earth leakage breaker 254. The extra output power socket 300 may be usefully utilized when the drain pump 12 is to be manually operated instead of being remotely controlled. By unplugging a plug of the pump power line 16 of the drain pump 12 from the pump power socket 290 and plugging it into the output power socket 300, manual switching may be easily performed. When the extra output power socket 300 is a socket with two or more outlets, it may be utilized not only for pump power connection for manual operation but also for power supply of an external WiFi repeater, a wireless communication router, or a remote camera required for remote control.

Through such a configuration of the remote control systems 100, with a single remote control systems 100, power may be supplied to two or more electronic valves 14a, 14b, one drain pump 12, and a wireless communication router or a WiFi repeater, and further, the drain pump 12 may be easily switched from a remote control mode to a manual mode. For reference, since the electronic valves 14a, 14b have automatic/manual mode switching switches installed in their bodies, it is not necessary to provide an automatic/manual switching function in the remote control systems 100.

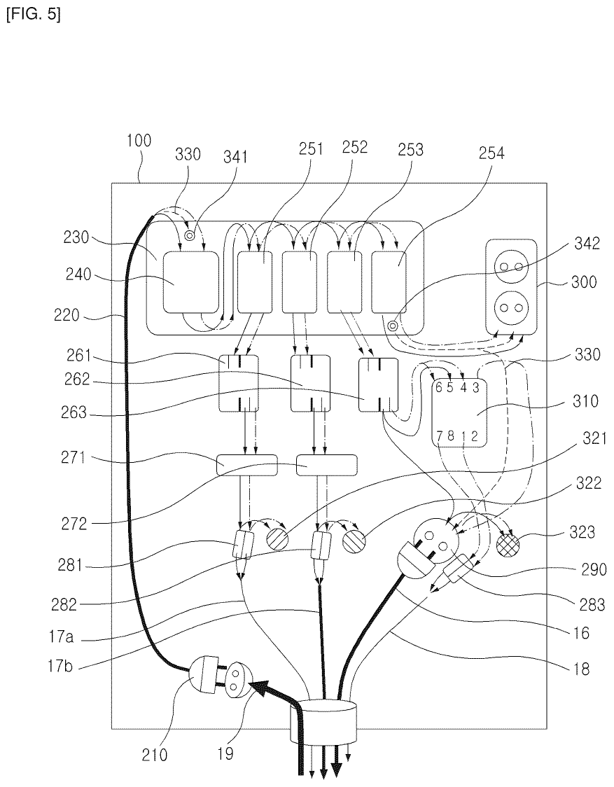

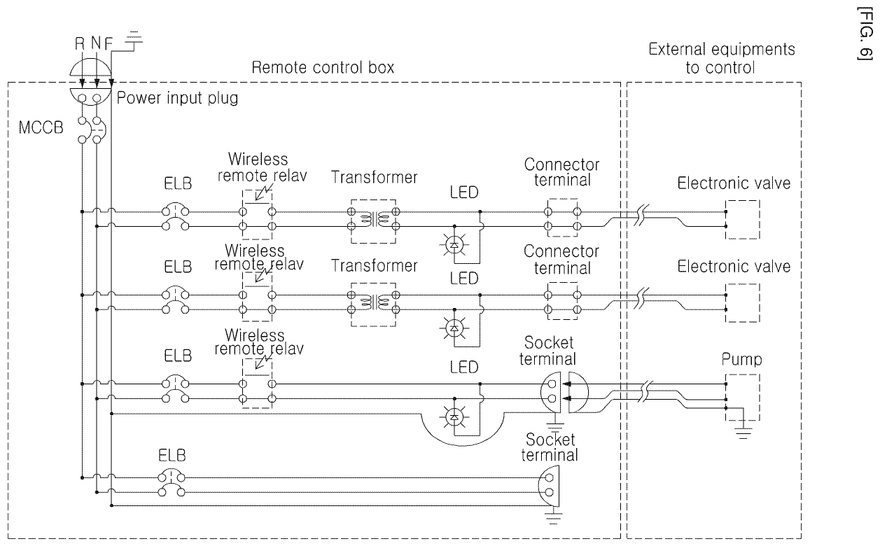

FIG. 5 is a plan layout view specifically illustrating components constituting the remote control systems 100 of FIG. 3.

Referring to FIG. 5 together with FIG. 3, functions and arrangements of components of the remote control systems 100 of FIG. 3 are illustrated.

In the remote control systems 100 for interlocking the water level sensing ball sensor 15 of the water tank 11 with the drain pump 12, a water level sensing controller 310 is installed between the wireless remote relay 263 and the pump power socket 290 in the pump control unit 180. The water level sensing controller 310 uses an existing controller for ball sensors (for example, Youngjin YJ-EC-3 model), and this controller is mounted on an 8-pin relay socket (for example, CE certified KH-TDR-RS or KH-RS-RS) that uses a circular 8-pin terminal. A method of electrically connecting the wireless remote relay 263 and the pump power socket 290 to the 8-pin relay socket of the above model is illustrated. Numbers 1 to 8 inside a box representing the water level sensing controller 310 are the same as numbers indicated on certified products of the 8-pin relay socket. The power line 18 of the water level sensing ball sensor must be connected only to specific numbered terminals of the 8-pin relay socket of the water level sensing controller 310. Since confusion may arise in selecting a terminal for the power line 18 of the water level sensing ball sensor, in order to allow easier connection, a sensor line connector terminal 283, which is pre-connected to an appropriate terminal of the water level sensing controller 310, is installed inside the remote control systems 100.

In FIGS. 2 and 4, and FIGS. 3 and 5, the wireless remote relays 261, 262, 263 of the remote relay unit 130 and the transformers 271, 272 of the transformer unit 140 may be configured as individual products, or functions of several components may be integrated into a single circuit board. The connector terminals 281, 282, 283 of the connector terminal unit 150 for external equipment may also be integrated into the circuit board or some of them may be integrated into a separate circuit board. When functions of some of the above components are integrated into a single board, a safer and more compact system may be configured.

In the remote control systems 100 of FIGS. 4 and 5, in order to visually or camera-observably monitor on-off states of the electronic valves 14a, 14b and the drain pump 12, LED indicators 321, 322, 323 are respectively installed in parallel on the connector terminals 17a, 17b and on the pump power socket 290. The led indicators 321, 322 connected to the electronic valve connector terminals 281, 282 are installed as low-voltage type (for example, 24V) corresponding to the relevant voltage, and the led indicator 323 connected to the pump power socket 290 is installed as high-voltage type (for example, 220V) corresponding to the relevant voltage. When the front surface of the remote control systems 100 is made of an opaque material, the led indicators 321, 322, 323 may be installed on a front lid of the remote control systems 100. The led indicators 321, 322, 323 may also be configured by being integrated with the connector terminals 281, 282, 283 into a single circuit board.

In the remote control box 100 of FIGS. 4 and 5, the ground line 330 is connected to the pump power socket 290 and the output power socket 300 connected in three phases (for example, AC220V) in preparation for the components in the remote control box 100 and the leakage that may occur in the external connection device, and the ground line 330 is provided with the ground terminals 341 and 342 so that the ground line of the input power line 220 in the control box is connected to each of the sockets 290 and 300. As such, the remote control box 100 May be appropriately provided up to the ground line connection, thereby further ensuring electrical stability.

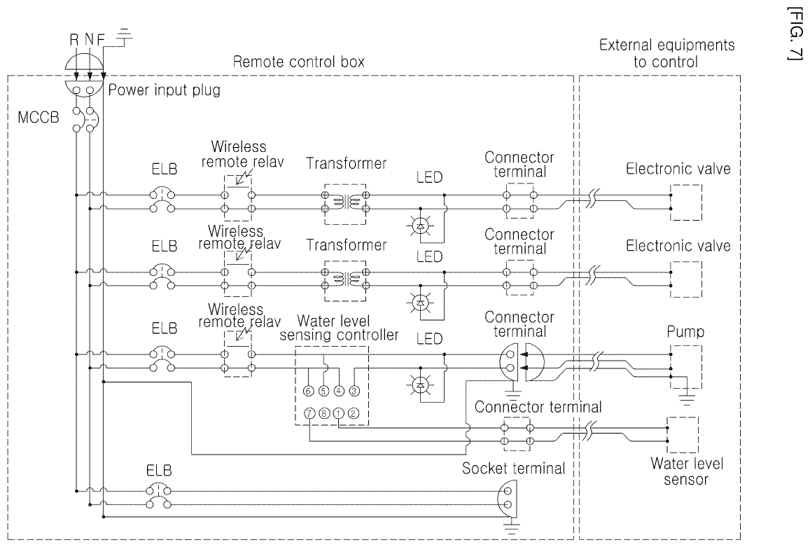

FIG. 6 is a circuit diagram of the remote control systems 100 of FIG. 4, and FIG. 7 is a circuit diagram of the remote control systems 100 of FIG. 5.

Referring to FIGS. 6 and 7, circuit diagrams corresponding to the plan layout views of FIGS. 4 and 5 are respectively illustrated. Names in the drawings are indicated with internationalized terms, and Korean descriptions corresponding to each English notation are indicated at the bottom of the drawings together with reference numerals. The circuits of FIGS. 6 and 7 are configured as systems supplied with three-phase power such as AC220V with R, N, and E. In a system supplied with two-phase power such as AC110V, a wire corresponding to E (earth; ground) may be connected as a separate ground wire to an external ground.

In summary, the remote control systems 100, implemented to block rain and wind while allowing electromagnetic waves to pass through, comprises: the power input plug 210 supplied with power; at least one molded case circuit breaker 240 or at least one earth leakage breakers 251, 252, 253, 254 connected to the power input plug 210 for electrical safety; at least one wireless remote relay 261, 262 for an electronic valve, connected to at least one of the molded case circuit breaker 240 or the earth leakage breakers 251, 252, 253, 254, to remotely control at least one irrigation electronic valve 14a, 14b; at least one connector terminal 281, 282, connected to the wireless remote relays 261, 262 for the electronic valves, to mount power lines 17a, 17b of the electronic valves 14a, 14b; at least one wireless remote relay 263 for a pump, connected to at least one of the molded case circuit breaker 240 or the earth leakage breakers 251, 252, 253, 254, to remotely control the drain pump 12; and at least one pump power socket 290, connected to the wireless remote relay 263 for the pump, to mount a power line 16 of the drain pump 12.

According to various embodiments, the remote control systems 100 further includes a water level sensing controller 310 connected between the wireless remote relay 263 for the pump and the pump power socket 290, to interlock with a water level sensing ball sensor 15 installed in the external water tank 11 for preventing idle running of the drain pump 12.

According to various embodiments, the remote control systems 100 may further include transformers 271, 272 for voltage drop connected between the wireless remote relays 261, 262 for the electronic valves and the connector terminals 281, 282.

According to various embodiments, the remote control systems 100 further includes led indicators 321, 322, 323, installed on the connector terminals 281, 282 to observe on or off states of power loaded to the connector terminals 281, 282, and installed on the pump power socket 290 to observe an on or off state of power loaded to the pump power socket 290.

According to various embodiments, the remote control systems 100 further includes an output power socket 300 connected to one of the earth leakage breakers 251, 252, 253, 254 for supplying power to an external equipment.

The various embodiments of the present disclosure and the terms used therein are not intended to limit the technology described herein to particular embodiments, but are to be understood to encompass various modifications, equivalents, and/or alternatives of those embodiments. In connection with the description of the drawings, like reference numerals may be used for like elements. The singular forms “a”, “an”, and “the” may include the plural forms as well, unless the context clearly indicates otherwise. In this document, the terms “A or B”, “at least one of A and/or B”, “A, B, or C” or “at least one A, B, and/or C” and the like may include all possible combinations of the listed items together. The terms “first”, “second”, “first”, or “second” and the like may modify the elements in question, regardless of order or importance, and are only used to distinguish one element from another and do not limit the elements in question. When an element is referred to as being “(functionally or physically) connected” or “connected” to another element (e.g., a second element), the element may be directly connected to the other element, or may be connected through another element (such as a third element).

According to various embodiments, each component of the described components may comprise one or a plurality of entities. According to various embodiments one or more components or steps of those components described above may be omitted, or one or more other components or steps may be added. Alternatively or additionally, a plurality of components may be integrated into one component. In such a case, the integrated component may perform one or more functions of each component of the plurality of components the same as or similar to those performed by that component of the plurality before integration.

### DESCRIPTION OF SIGNS

10: Irrigation system
11: Water tank
12: Drain pump
13: Irrigation pipe
14a, 14b: Electronic valve
15: Water level sensing ball sensor

1. A remote control systems, configured to block rain and wind while allowing electromagnetic waves to pass through, comprising:
a power input plug supplied with power;
at least one molded case circuit breaker or at least one earth leakage breaker connected to the power input plug for electrical safety;
at least one wireless remote relay for an electronic valve, connected to at least one of the molded case circuit breaker or the earth leakage breaker, to remotely control at least one irrigation electronic valve;
at least one connector terminal, connected to the wireless remote relay for the electronic valve, to mount a power line of the electronic valve;
at least one wireless remote relay for a pump, connected to at least one of the molded case circuit breaker or the earth leakage breaker, to remotely control a drain pump for irrigation; and
at least one pump power socket, connected to the wireless remote relay for the pump, to mount a power line of the drain pump.

2. The remote control systems according to claim 1, further comprising:
a water level sensing controller connected between the wireless remote relay for the pump and the pump power socket, to interlock a water level sensing ball sensor installed in an external water tank with the drain pump in order to prevent idling of the drain pump.

3. The remote control systems according to claim 1 or 2, further comprising:
a transformer for voltage drop connected between the wireless remote relay for the electronic valve and the connector terminal.

4. The remote control systems according to claim 1 or 2, further comprising:
an LED indicator installed on the connector terminal to observe an on or off state of power loaded to the connector terminal, and installed on the pump power socket to observe an on or off state of power loaded to the pump power socket.

5. The remote control systems according to claim 1 or 2, further comprising:
an output power socket connected to one of the earth leakage breakers to supply power to external equipment.
